(19) United States
(12) Patent Application Publication
(10) Pub. No.: US 2006/0066986 A1
(43) Pub. Date: Mar. 30, 2006

(54) Seek servomechanism with extended sinusoidal current profile

(76) Inventor: Teng-yuan Shih, San Jose, CA (US)

Correspondence Address: Teng-yuan Shih, 1197 Valley Quail Circle, San Jose, CA, 95120, US

(21) Appl. No.: 10/950,099

(22) Filed: Sep. 24, 2004

(51) Int. Cl. G11B 5/596

(52) U.S. Cl. 360/78.06

(57) ABSTRACT

A hard disk drive moves a transducer (or recording head) across a disk surface so that the transducer has an essentially extended sinusoidal acceleration trajectory. The transducer may be integrated into a slider that is incorporated into a head gimbal assembly (HGA). The HGA may be mounted to an actuator arm, which can move the transducer across the disk surface. The movement of the actuator arm and the transducer may be controlled by a controller. The function of a controller is to move the transducer from its present track to a target track in accordance with a seek routine and a servo control routine. During the seek routine the controller may move the transducer in accordance with an extended sinusoidal current trajectory. The extended sine wave is devised to be current profiles for use in seeks control to move a recording head from one position to another position fast and robustly. The extended sinusoidal waveform as a current profile may provide a balance design to achieve near time-optimal seek performance, and, at the same time, to minimize mechanical resonance and its associated acoustic noise generated during seeks. This extended sine wave as current profile for a seek servomechanism may have the advantages of being more controllable than conventional bang-bang control and faster than a sinusoidal seek algorithm. The extended sinusoidal waveform is very general, which represents a new class of versatile trajectories. Both the conventional bang-bang trajectory and the sinusoidal trajectory are limiting cases of the extended sinusoidal waveform.

### BACKGROUND OF THE INVENTION

1. Field of the Invention

The present invention relates generally to the design of a method and apparatus for seek control algorithm of servo system design associated with a hard disk drive. More specifically, the invention devises an extended sinusoidal waveform as current profile for a seek controller to move data heads of a hard disk drive from one position to another position fast and robustly. The controller forces the motion of recording heads to follow the seek trajectories during the process of seeks, including acceleration, velocity and position, which are derived from the design current profile.

2. Background

Hard disk drives include a plurality of magnetic transducers that can write and read information by magnetizing and sensing the magnetic field of a spinning disk(s), respectively. The information is typically formatted into a plurality of sectors that are located within an annular track. There are a number of tracks located across each surface of the disk. A number of vertically aligned tracks are usually referred to as a cylinder.

Each transducer is integrated into a slider that is incorporated into a head gimbal assembly (HGA), which is referred to as either a head or recording head in the following. Each HGA is attached to an actuator arm. The actuator arm is actuated by a voice coil motor (VCM), which is attached to the actuator assembly, and is composed of a coil and a magnetic circuit device. The hard disk drive typically includes a driver circuit and a controller that provide current to excite the VCM in accordance with a servo algorithm. The excited VCM is the energy source to rotate the actuator arm and moves the heads (or, synonymously, transducers) across the surfaces of the disk(s).

When writing or reading information the hard disk drive performs a seek routine to move a head (transducer) from one track to its target track on a disk surface. The controller performs a servo routine to assure the transducer moves to the target position fast and accurately. It is always desirable to minimize the amount of time required to write to and to read from the disk(s). Therefore, the seek routine performed by the drive should move the heads to new positions in shortest possible time. Additionally, the settling time of the HGA should be minimized so that the heads can quickly start the read or write operation when they arrive the commend targets.

Prior art of seek control algorithms includes two major seek trajectories: bang-bang control trajectory and standard sinusoidal trajectory. Many disk drive designs utilize a bang-bang control algorithm for the servo routine to move the recording heads (transducers) because the bang-bang trajectory is theoretically the time optimal method for seek control to move a transducer from its present position to any target position in shortest time. The waveform of the bang-bang current profile is a positive square wave followed by another square wave in opposite direction. Square waveforms contain high frequency harmonics, which are likely to stimulate mechanical resonance of the mechanical system of a hard disk drive. Moreover, the current rise time and current switching time for the bang-bang profile are infinitely fast, which is physically not possible. For practical implementation, various modifications are usually necessary to trim the bang-bang trajectory for a servo algorithm to work well for a hard disk drive. With all these modifications, the bang-bang algorithm is no longer time-optimal for seeks. The mechanical vibrations excited by a bang-bang current profile due to its wide range of frequency contents are often unacceptable for the servo system because of the consideration of stability margin. Additionally, these vibrations are a major source generating acoustic noises during seeks.

A sinusoidal wave of prior art as current profile for seeks has been used to replace a bang-bang trajectory for seeks control in the hard disk drive industry. A standard sinusoidal seek trajectory is simply a sine function with seek-length dependent period. There are, at least, two noticeable reasons for the change. First, a sinusoidal wave has only one frequency component, which is less likely to excite the mechanical system of a drive. Second, the sinusoidal current profile is very smooth because of the gentle current rise and current reverse, and, additionally, the current gradually reduces to zero at the target position for smooth landing. The major shortcoming of a sinusoidal current profile is due to its rigid waveform. The current rise time of the sinusoidal seek is set by the waveform, and once the current reaches its design peak, it starts to fall off following the sinusoidal waveform. In other words, the sinusoidal wave lacks the capability to stay at the design current peak for a finite duration of time; therefore, the only method to improve the movement time of seeks is to increase the amplitude of the current profile, which is usually not possible.

The current trajectory of an extended sine wave is essentially a sinusoidal wave with the extension that it allows the trajectory to stay at its design peak value (positive for acceleration and negative for deceleration) for a fixed duration of time for faster seek time. The current profile with the extended sine wave is very flexible for tuning seek performance. The duration of either the constant acceleration peak or the constant deceleration peak of the trajectory can be easily adjusted and tuned for performance. The extended sinusoidal trajectory for current profile is very general because it includes both the bang-bang trajectory and the sinusoidal seek trajectory as its two extreme limiting cases. The extended sinusoidal current profile possesses the performance advantages of both bang-bang design and the sinusoidal seek design. A seek control using the extended sinusoidal current profile is both fast and robust.

There is an approach of prior art following the lines of concept similar to this invention to generate the acceleration trajectory for seek by employing a Fourier series representation with a finite number of terms. For implementation consideration, the number of terms is limited to very few, such as two or three. Special efforts are made to eliminate the well-known Gibbs phenomenon of classical Fourier analysis in the constant acceleration portion of the trajectory. Thus, the approach for seek is named a generalized Fourier seek method because it is not an ordinary Fourier series. The method is capable of generating an acceleration trajectory with constant maximum acceleration for certain duration of time. The duration of constant acceleration generated by the Fourier seek method is generally not easily adjustable. An optimization method to choose Fourier coefficients by minimizing the total mean-square error in the constant acceleration phase exists in prior art. Such a generalized Fourier seek method coupled with the optimization method for the determination of series coefficients involves quite some mathematical manipulations. A major shortcoming of the method is its relative inflexibility to adjust the duration of constant phase in the acceleration trajectory. The extended sinusoidal trajectory, on the other hand, works directly on the geometry of the standard sinusoidal waveform to insert a constant phase of acceleration. Therefore, the method is very general and flexible for the adjustment of the duration of constant acceleration phase in the acceleration trajectory. Additionally, the direct method of waveform modification in the invention is simpler to use for implementation.

The seek trajectories using the extended sinusoidal waveform as the current profile of seeks consist of three trajectories. The acceleration trajectory is essentially the same as the current trajectory with the only difference of a proportional constant. The acceleration trajectory is a curve with time as a parameter. The acceleration trajectory is integrated once with respect to the parameter of time to yield the velocity trajectory. The velocity trajectory is integrated once more to yield the position trajectory, which is also called the displacement trajectory. These theoretically generated trajectories based on the extended sinusoidal waveform are the design trajectories for use with the seek controllers in the invention.

The extended sinusoidal waveform is constructed by saturating the standard sinusoidal wave at a specified level smaller than unity. The resulting waveform is then normalized to have unit amplitude. The extended sinusoidal wave is capable of moving the heads faster to target positions because of its higher energy content compared to the sinusoidal seek method. The specified level for the construction of the extended sinusoidal waveform is adjustable. Depending on seek length, the recommended strategy of trajectory usage is a combination of different saturation levels of the waveform construction. Typically, no saturation model, which reduces to the standard sinusoidal model, shall be applied for short to medium range seeks, and, for relatively longer seeks, a saturation level between 0 and 1 shall be set before normalization for better seek time performance.

### SUMMARY

One embodiment of the present invention is a hard disk drive, which moves a transducer (or recording head) across a disk surface so that the transducer has an extended sinusoidal current trajectory. The extended sine wave is devised to be current profiles for use in seeks control to move a recording head from one position to another position as fast as possible. The extended sinusoidal waveform as a current profile provides a design compromise to achieve near time-optimal seek performance, and, at the same time, to minimize mechanical resonance and its associated acoustic noise generated during seeks. An extended sine wave is generated from a standard sine wave by saturating the sine function to a specified value, which is less than a unity. This saturated sine function is then normalized so that it has unit amplitude. This extended sine wave as current profile for a seek servomechanism has the advantages of being more controllable than a prior art of conventional bang-bang control and faster than another prior art of sinusoidal seek algorithm. Since the maximum current of an extended sine wave can stay at its peak for a fixed duration of time, the current trajectory is devised for designing certain seek profiles to achieve fast access time in hard disk drive applications. A controller using seek trajectory on the phase plane may be used to incorporate the extended sinusoidal trajectory for best benefits. One major application of the new class of seek trajectories is to improve the seek time for long seeks because faster seek time can be achieved without the need to increase maximum current. The other application of the trajectory is in designing hard drive for extreme operating temperatures by increasing the duration of constant peak current when maximum current output is a restraint. The method using extended sine wave is both general, flexible and powerful compared to the prior art of either bang-bang control algorithm or sinusoidal seek method.

### DRAWINGS

FIG. 1. Generation of Extended Sinusoidal Waveform without Coast Mode
(a) Construction of Waveform (Restraint: 0<p<1)
(b) Resulting Extended Sinusoidal Waveform after Normalization (Full Cycle of Extended Sine Wave with Coast Mode: Trajectory a-b-c-d-e-f)

FIG. 2. A Typical Extended Sinusoidal Waveform with Coast Mode
(a) Extended Sinusoidal Wave with Coordinates of Border Points between Phases
(b) Extended Sinusoidal Wave with Border Points between Phases on Trajectory (Full Cycle of Extended Sine Wave with Coast Mode: Trajectory a-b-c-d-e-f-g-h)

FIG. 3. Comparison of Seek Trajectories for the Extended Sinusoidal Wave—-Extended Sinusoidal Wave (p=0.5) with Standard Sinusoidal Model

FIG. 4. Comparison of Seek Trajectories for the Extended Sinusoidal Wave—-Extended Sinusoidal Wave (p=0.8) with Standard Sinusoidal Model

FIG. 5. Conversion of Seek Trajectories of Parametric Form to the Phase Plane

FIG. 6. Comparison of Seek Trajectories on the Phase Plane—-Extended Sinusoidal Wave (p=0.5) with Standard Sinusoidal Model

FIG. 7. Comparison of Seek Trajectories on the Phase Plane—-Extended Sinusoidal Wave (p=0.8) with Standard Sinusoidal Model

FIG. 8. Comparison of Parametric Seek Trajectories with Coast Mode—-Extended Sinusoidal Wave (p=0.65, C=0.2) with Standard Sinusoidal Model

FIG. 9. Comparison of Seek Trajectory on Phase Plane with Coast Mode—-Extended Sinusoidal Wave (p=0.65, C=0.2) with Standard Sinusoidal Model

FIG. 10. Seek Time Comparison of Different Waveforms—-Extended Sine Model (p=0.5) versus Sinusoidal and Bang-Bang-Control

FIG. 11. Seek Time Comparison of Different Waveforms—-Extended Sine Model (p=0.8) versus Sinusoidal and Bang-Bang-Control

FIG. 12. Controller Using Parametric Seek Trajectories (Seeks without Coast Mode)

FIG. 13. Controller Using Seek Trajectory on Phase Plane (Seeks without Coast Mode)

FIG. 14. Controller Using Parametric Seek Trajectories (Seeks with Coast Mode)

FIG. 15. Controller Using Seek Trajectory on Phase Plane (Seeks with Coast Mode)

### DETAILED DESCRIPTION

1. Generation of Current Profile

An extended sinusoidal waveform is constructed by limiting the standard sine function to saturate at a specified level as illustrated in FIG. 1(a). The resulting waveform is then normalized so that its peak value is exactly one as shown in FIG. 1(b).

For a seek without coast mode, the current trajectory using the extended sine function can be divided into five phases as shown in FIG. 1(b):
1. Phase I: Acceleration phase (Initial seek phase)
2. Phase II: Constant acceleration phase
3. Phase III: Transition phase
4. Phase IV: Constant deceleration phase
5. Phase V: Approaching phase (Near the end-of-seek phase)

Notice that the transition phase covers the duration of seek from acceleration to deceleration.

When a coast mode is present in seeks, a phase of zero acceleration is inserted in between the acceleration mode and the deceleration mode. During the coast mode, the maximum velocity remains as a constant, which is the maximum design velocity of the transducer(s) to read Gray code reliably. Due to the addition of the coast mode, there are two addition phases in the current profile. Depending on the slope of the current profile, the acceleration phase of the current profile is further divided into the initial acceleration phase where slope

$$\frac{ⅆ a ( x )}{ⅆ x} > 0$$

and the final acceleration phase slope

$$\frac{ⅆ a ( x )}{ⅆ x} < 0.$$

Similarly, the deceleration phase is decomposed into two separate phases depending on the slope of the current profile: initial deceleration phase for slope

$$\frac{ⅆ a ( x )}{ⅆ x} < 0$$

and final deceleration phase for slope

$$\frac{ⅆ a ( x )}{ⅆ x} > 0.$$

The extended sinusoidal waveform with a coast mode is illustrated with a sketch in FIG. 2.

These seven phases of the extended sinusoidal current profile for seeks with a coast mode are

$$1. Phase I \text{:}$$

$$Initial acceleration phase ( 0 \leq a ( x ) < 1 and slope \frac{ⅆ a ( x )}{ⅆ x} > 0 )$$

$$2. Phase II \text{:}$$

$$Constant acceleration phase ( a ( x ) = 1 > 0 and slope \frac{ⅆ a ( x )}{ⅆ x} = 0 )$$

$$3. Phase III \text{:}$$

$$Final acceleration phase ( 0 \leq a ( x ) < 1 and slope \frac{ⅆ a ( x )}{ⅆ x} < 0 )$$

$$4. Phase IV \text{:}$$

$$Coast mode phase ( slope \frac{ⅆ a ( x )}{ⅆ x} > 0 )$$

$$5. Phase V \text{:}$$

$$Initial deceleration phase ( - 1 < a ( x ) \leq 0 and slope \frac{ⅆ a ( x )}{ⅆ x} < 0 )$$

$$6. Phase VI \text{:}$$

$$Constant deceleration phase ( a ( x ) = - 1 < 0 and slope \frac{ⅆ a ( x )}{ⅆ x} = 0 )$$

$$7. Phase VII \text{:}$$

$$Final deceleration phase ( - 1 < a ( x ) \leq 0 and slope \frac{ⅆ a ( x )}{ⅆ x} > 0 )$$

The final deceleration phase is synonymous with the approaching phase (or near the end-of-seek phase).

2. Seek Trajectories without Coast Mode

As shown in FIG. 1(a), the amplitude of an extended sine wave is denoted by p, which is a parameter falling in the range of 0<p<1. In the limiting case when p→1, the extended sine wave reduces to a standard sine wave. Another limiting case when p→0 is the classical bang-bang control curve. Let the duration of the acceleration phase be denoted by A. There is a restraint on the parameter A:

$$A \leq \frac{1}{4} .$$

The extended sine model is powerful in the sense that the seek time can be very fast by decreasing the parameter p without the need to increase the maximum current as is required for a sinusoidal seek model.

For a given truncated value p, the duration of acceleration phase A is given by

$${x}_{p} = \frac{1}{2 π} {sin}^{- 1} p ≡ A \qquad ( 1 )$$

In Eq. (1), there are two restraints on the two parameters A and p:

$$0 < p \leq 1 and A \leq \frac{1}{4} \qquad ( 2 )$$

In the following, the acceleration (or current trajectory) is limited by a preset value of p instead of 1. Therefore, all the trajectories given in the following have to be scaled by a factor of 1/p for normalization.

The current profile a(x) in phase I has the property of a(x)>0 with its slope

$$\frac{ⅆ a ( x )}{ⅆ x} > 0 ,$$

and the a(x) reaches its maximum when the slope of current decreases to 0. In phase II, the current is a positive constant, and the slope of current is zero. Depending on the sign of the acceleration slope, Phase III can be further separated into two sub-phases, phase III-A and phase III-B. In phase III-A, we have a(x)>0 and its slope

$$\frac{ⅆ a ( x )}{ⅆ x} < 0.$$

In phase III-B, we have a(x)<0 and its slope

$$\frac{ⅆ a ( x )}{ⅆ x} < 0 too .$$

The current a(x) reaches its minimum when its slope increases to zero. In phase IV, the current is a negative constant, and the slope of current is zero. In phase V, we have a(x)<0 and its slope

$$\frac{ⅆ a ( x )}{ⅆ x} > 0.$$

Note that the slope of the extended sine wave is not continuous at the boundary points between neighboring phases. As shown in FIG. 1(b), these boundary points between neighboring phases are the points of b, c, d and e.

Before normalization for unit acceleration amplitude, the trajectories for these five phases are given in the following.
Acceleration Profile

$$\begin{matrix}{a}_{I} ( x ) = sin ( 2 π x ) , 0 \leq x \leq A & ( 3 ) \\ {a}_{II} ( x ) = p , A < x \leq \frac{1}{2} - A & ( 4 ) \\ {a}_{III} ( x ) = sin ( 2 π x ) , \frac{1}{2} - A < x \leq \frac{1}{2} + A & ( 5 ) \\ {a}_{IV} ( x ) = - p , \frac{1}{2} + A < x \leq 1 - A & ( 6 ) \\ {a}_{V} ( x ) = sin ( 2 π x ) , 1 - A < x \leq 1 & ( 7 )\end{matrix}$$

The current trajectory for Phase I, Phase II and Phase III are coincident with separate portions of one cycle of sine function. Notice that there are no phase delays involved in these three trajectory phases.
Velocity Profile

$$\begin{matrix}{v}_{I} ( x ) = \frac{1}{2 π} ( 1 - cos 2 π x ) , 0 \leq x \leq A & ( 8 ) \\ {v}_{II} ( x ) = {v}_{1} + p ( x - A ) , A < x \leq \frac{1}{2} - A & ( 9 ) \\ {v}_{III} ( x ) = {v}_{2} + \frac{1}{2 π} [ cos π ( 1 - 2 A ) - cos 2 π x ] , \frac{1}{2} - A < x \leq \frac{1}{2} + A & ( 10 ) \\ {v}_{IV} ( x ) = {v}_{3} - p ( x - \frac{1}{2} - A ) , \frac{1}{2} + A < x \geq 1 - A & ( 11 ) \\ {v}_{V} ( x ) = {v}_{4} + \frac{1}{2 π} [ cos 2 π ( 1 - A ) - cos 2 π x ] , 1 - A < x \leq 1 & ( 12 )\end{matrix}$$

Initial conditions in the velocity trajectories for, Phase II through Phase V are
Position Profile

$$\begin{matrix}{d}_{I} ( x ) = \frac{1}{2 π} [ x - \frac{1}{2 π} sin 2 π x ] , 0 \leq x \leq A & ( 13 ) \\ {d}_{II} ( x ) = {d}_{1} + ( {v}_{1} - p A ) ( x - A ) + \frac{p}{2} ( {x}^{2} - {A}^{2} ) , A < x \leq \frac{1}{2} - A & ( 14 ) \\ {d}_{III} ( x ) = {d}_{2} - \frac{1}{2} [ {v}_{2} + \frac{1}{2 π} cos π ( 1 - 2 A ) ] ( 1 - 2 A ) - \frac{1}{{( 2 π )}^{2}} [ sin 2 π x - sin π ( 1 - 2 A ) ] + [ {v}_{2} + \frac{1}{2 π} cos π ( 1 - 2 A ) ] x , \frac{1}{2} - A < x \leq \frac{1}{2} + A & ( 15 ) \\ {d}_{IV} ( x ) = {d}_{3} + [ {v}_{3} + \frac{1}{2} + A ] ( x - \frac{1}{2} - A ) - \frac{p}{2} [ {x}^{2} - {( \frac{1}{2} + A )}^{2} ] , \frac{1}{2} + A < x \leq 1 - A & ( 16 ) \\ {d}_{V} ( x ) = {d}_{4} + [ {v}_{4} + \frac{1}{2 π} cos 2 π ( 1 - A ) ] ( x - 1 + A ) - \frac{1}{{( 2 π )}^{2}} [ sin 2 π x - sin 2 π ( x + 1 - A ) ] , 1 - A < x \leq 1. & ( 17 )\end{matrix}$$

Initials positions in the position trajectories for Phase II through Phase V are

$$\begin{matrix}{d}_{1} = {d}_{I} ( A ) & ( 18 ) \\ {d}_{2} = {d}_{II} ( \frac{1}{2} - A ) & ( 19 ) \\ {d}_{3} = {d}_{III} ( \frac{1}{2} + A ) & ( 20 ) \\ {d}_{4} = {d}_{IV} ( 1 - A ) & ( 21 )\end{matrix}$$

Multiplying by 1/p, every one of these seeks trajectories given above is normalized to yield the trajectories with unit acceleration amplitude.

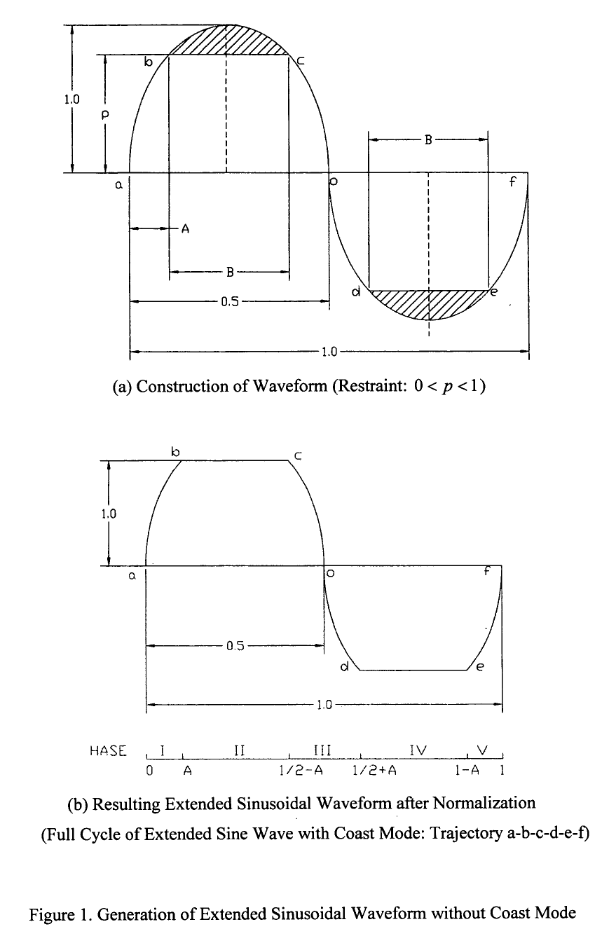

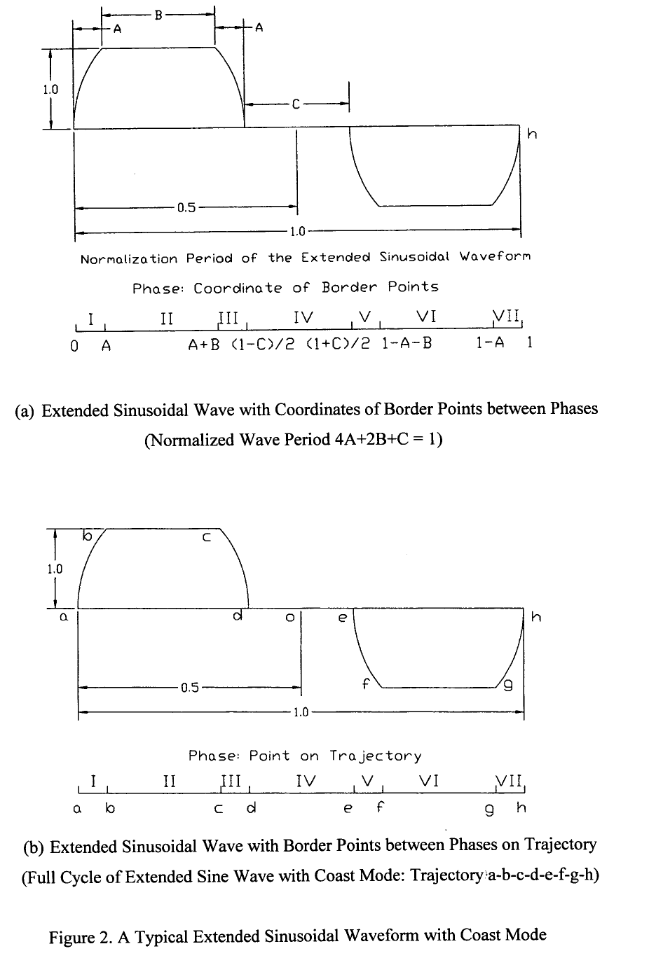

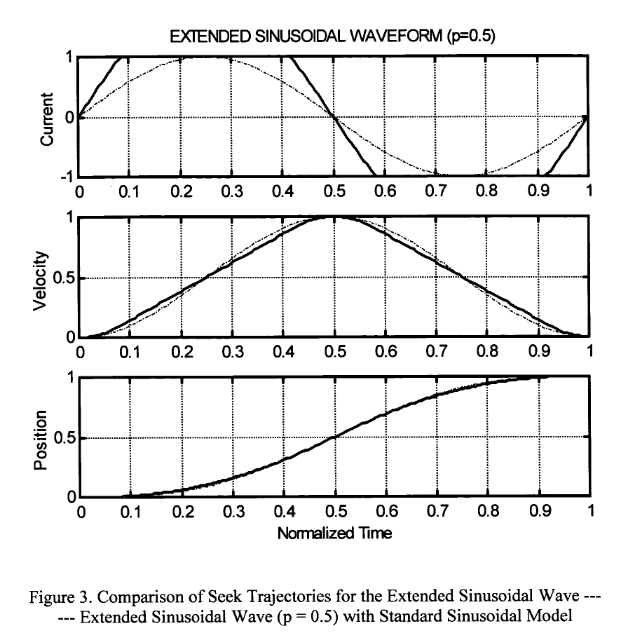

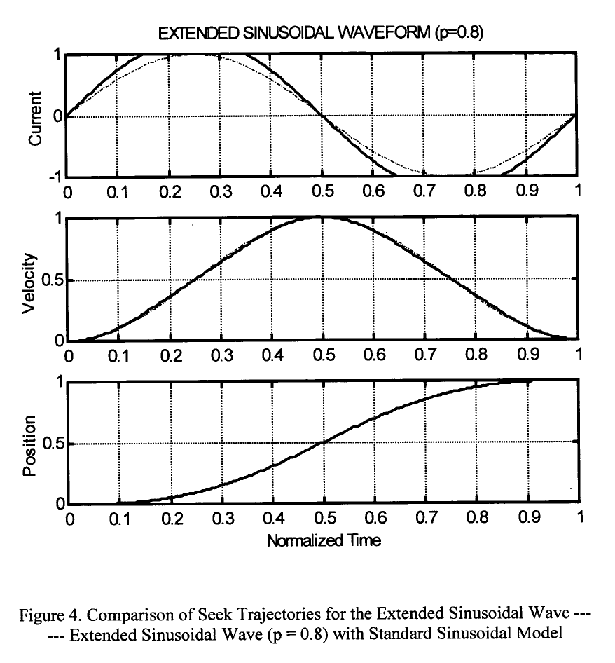

The comparison of seek trajectories with extended sinusoidal current waveform (p=0.8) with the corresponding trajectories of the sinusoidal seek method is shown in FIG. 3 and FIG. 4 for p=0.5 and p=0.8, respectively.

3. Trajectory on the Phase Plane

The seek trajectories, including acceleration or current, velocity and position, have been expressed as functions of time. Since the time is a parameter in each design profile, these profiles are referred to as trajectories of the parametric form.

Depending on the design of seek controller, there are two possible methods to apply the extended sinusoidal wave to seeks in the servomechanism of hard disk drive. The first type seek controller is the conventional approach, which relies on the availability of seek trajectories at any instant of servo interrupt. Since these seek profiles are available at any time instant, they are the parametric trajectories.

The current trajectory is always given in parametric form because the major part of the current input to voice coil motor (VCM) is based on this design trajectory. However, the velocity trajectory and the position trajectory can be combined into a single trajectory on the phase plane by explicitly eliminated the time variable from these trajectories equations. The second type seek controller uses the seek trajectory on the phase plane. At any instant of servo interrupt, the head position is measured with a sensor. Alternatively, the head position is estimated using an estimator (or observer) when it is available in the servo system design. Given the head position from either the position sensor output or the estimator output, the design velocity at that particular position is extracted from the seek trajectory on the phase plane. The design velocity at that position is then compared against the actual velocity at that instant from either the estimator output or a tachometer output.

Using either one of the two seek controllers, the controller output consists of three parts:
(1) The current corrections associate with the differences between the design velocity and measured velocity, and between the design position and measured position. These error terms are scaled by appropriate gains to yield current corrections.
(2) The design current, which is based on current trajectory at the instant of servo interrupt.
(3) The adjustment current to account for bias caused by flex cable and other possible sources

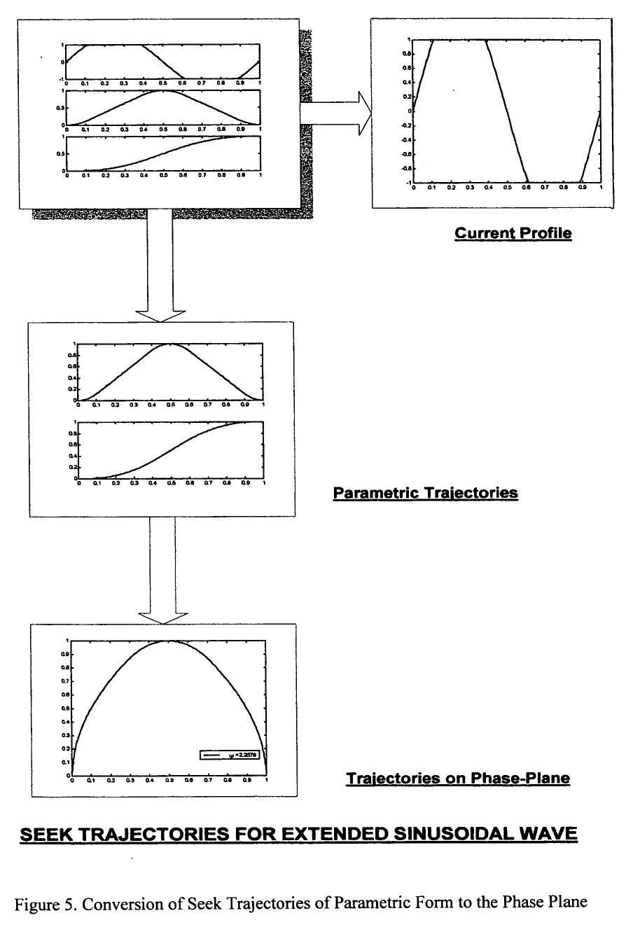

FIG. 5 presents an illustration of the procedures to generate the seek trajectory on the phase plane. The seek trajectory on the phase plane has the velocity as the coordinate and the position as the abscissa.

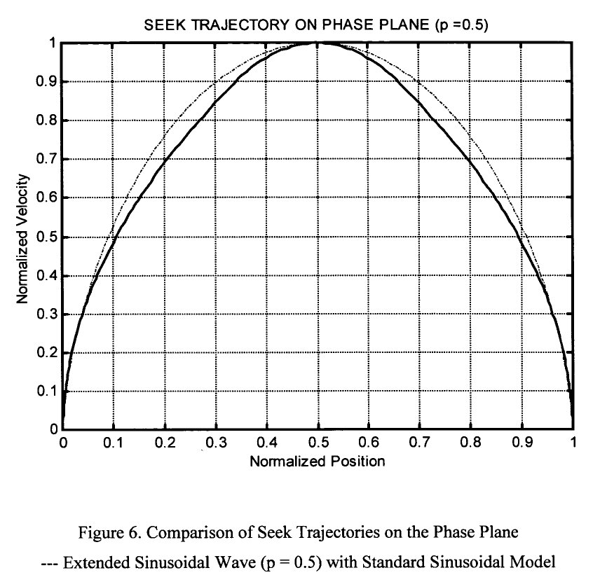

The parametric seek trajectories for velocity and position in FIG. 3 are combined into a single seek trajectory on the phase plane of FIG. 6. There are two seek trajectories on the same phase plane for the extended sinusoidal waveform with p=0.5 (continuous line) and the standard sinusoidal waveform (dashed line) for comparison.

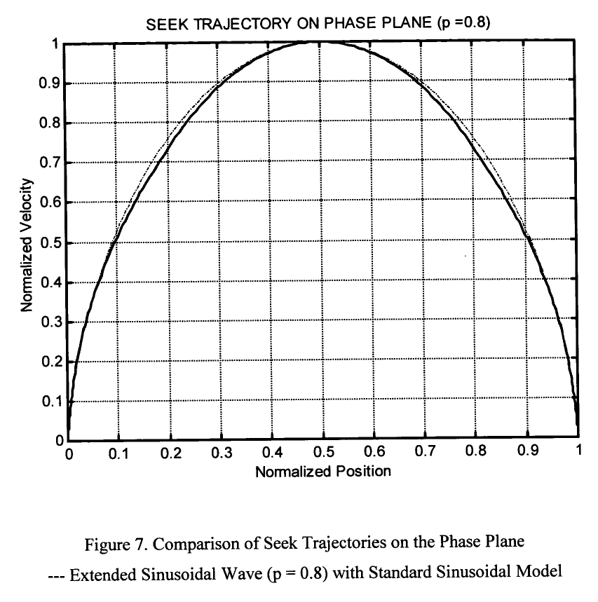

The parametric seek trajectories for velocity and position in FIG. 4 are combined into the seek trajectory on the phase plane of FIG. 7. There are two seek trajectories on the same phase plane for the extended sinusoidal waveform with p=0.8 (continuous line) and the standard sinusoidal waveform (dashed line) for comparison.

4. Trajectories with Coast Mode

A coast mode is present in the extended sinusoidal waveform for relatively long seeks, which has zero acceleration. The notation A stands for the duration of the initial acceleration phase, which is equal to the duration of the final acceleration phase, initial deceleration phase or final deceleration phase. Denote the duration of coast mode by C, and the duration of either constant acceleration or deceleration by B. As shown in FIG. 2(a), we have the following relationship for the normalized extended sinusoidal current profile.
4A+2B+C=1. (22)

Define the symbols

$$\begin{matrix}Θ = 2 π \frac{C}{1 - C} & ( 23 ) \\ Ω = \frac{2 π}{1 - C} & ( 24 ) \\ Λ = \frac{1}{Ω} = \frac{1 - C}{2 π} & ( 25 )\end{matrix}$$

For seeks with coast mode, there are two additional phases than the case without coast mode.

Phase I: Initial acceleration phase (0≦x≦A)
a_{I}(x)=sin Ωx (26)
v_{I}(x)=Λ(1−cos Ωx) (27)
d_{I}(x)=Λ(x−Λ sin Ωx) (28)
Phase II: Constant acceleration phase (A<x≦½(1−C)−A

$$\begin{matrix}{a}_{II} ( x ) = p & ( 29 ) \\ {v}_{II} ( x ) = {v}_{1} + p ( x - A ) & ( 30 ) \\ {d}_{II} ( x ) = {d}_{1} + ( {v}_{1} - pA ) ( x - A ) + \frac{p}{2} {( x - A )}^{2} & ( 31 )\end{matrix}$$

Phase III: Final acceleration phase (½(1−C)<x≦½(1−C))

$$\begin{matrix}{a}_{III} ( x ) = sin Ω x & ( 32 ) \\ {v}_{III} ( x ) = {v}_{2} + Λ \{ cos Ω [ \frac{1}{2} ( 1 - C ) - A ] - cos Ω x \} & ( 33 ) \\ {d}_{III} ( x ) = {d}_{2} + \{ {v}_{2} + Λ cos Ω [ \frac{1}{2} ( 1 - C ) - A ] \} [ x - \frac{1}{2} ( 1 - C ) + A ] - {Λ}^{2} \{ sin Ω x - sin Ω [ \frac{1}{2} ( 1 - C ) - A ] \} & ( 34 )\end{matrix}$$

Phase IV: Coast mode phase (Coast Mode) (½(1−C)<x≦½(1+C))

$$\begin{matrix}{a}_{IV} ( x ) = 0 & ( 35 ) \\ {v}_{IV} ( x ) = {v}_{3} = {V}_{Max} & ( 36 ) \\ {d}_{IV} ( x ) = {d}_{3} + {v}_{3} [ x - \frac{1}{2} ( 1 - C ) ] & ( 37 )\end{matrix}$$

Phase V: Initial deceleration phase ((½((1+C)<x≦½(1+C)+A)
aᵥ(x)=sin(Ωx−Θ) (38)

$$\begin{matrix}{v}_{V} ( x ) = {v}_{4} - Λ [ - cos ( \frac{Ω ( 1 + C )}{2} - Θ ) + cos ( Ω x - Θ ) ] & ( 39 ) \\ {d}_{V} ( x ) = {d}_{4} + [ {v}_{4} + Λ cos ( \frac{Ω ( 1 + C )}{2} - Θ ) ] [ x - \frac{1}{2} ( 1 + C ) ] - {Λ}^{2} [ sin ( Ω x - Θ ) - sin ( \frac{Ω ( 1 + C )}{2} - Θ ) ] & ( 40 )\end{matrix}$$

Phase VI: Constant deceleration phase (½(1+C)+A<x≦1−A)

$$\begin{matrix}{a}_{VI} ( x ) = - p & ( 41 ) \\ {v}_{VI} ( x ) = {v}_{5} - p [ x - \frac{1}{2} ( 1 + C ) - A ] & ( 42 ) \\ {d}_{VI} ( x ) = {d}_{5} + [ {v}_{5} + \frac{p}{2} ( 1 + C ) + Ap ] [ x - \frac{1}{2} ( 1 + C ) - A ] - \frac{p}{2} [ {x}^{2} - \frac{{( 1 + C + 2 A )}^{2}}{4} ] & ( 43 )\end{matrix}$$

Phase VII: Final deceleration phase (1−A<x≦1)
a_{VII}(x)=sin(Ωx−Θ) (44)
v_{VII}(x)=v₆+Λ{cos[Ω(1−A)−Θ)]−cos(Ωx−Θ)} (45)
d_{VII}(x)=d₆+{v₆+Λ cos[Ω(1−A)−Θ]}(x−1+A)−Λ²{sin(Ωx−Θ)−sin[Ω(1−A)−Θ)]} (46)

In the generation of seek trajectories for Phase II through Phase VII of seeks with coast mode, we need initial conditions including initial velocity and initial position, which are the terminal velocity and terminal position at the end of previous phases.

Initial velocities of these trajectories for Phase II through Phase VII are as follows: These initial velocities are the terminal velocities at the end of previous phases.

$$\begin{matrix}{v}_{1} = {v}_{I} ( A ) & ( 47 ) \\ {v}_{2} = {v}_{II} [ \frac{1}{2} ( 1 - C ) - A ] & ( 48 ) \\ {v}_{3} = {v}_{III} [ \frac{1}{2} ( 1 - C ) ] & ( 49 ) \\ {v}_{4} = {v}_{IV} [ \frac{1}{2} ( 1 + C ) ] = {V}_{Max} & ( 50 ) \\ {v}_{5} = {v}_{V} [ \frac{1}{2} ( 1 + C ) + A ] & ( 51 ) \\ {v}_{6} = {v}_{VI} ( 1 - A ) & ( 52 )\end{matrix}$$

Initial displacements of these trajectories for Phase II through Phase VII are given below. These initial displacements (or positions) are the terminal positions at the end of each trajectory of previous phases.

$$\begin{matrix}{d}_{1} = {d}_{I} ( A ) & ( 53 ) \\ {d}_{2} = {d}_{II} [ \frac{1}{2} ( 1 - C ) - A ] & ( 54 ) \\ {d}_{3} = {d}_{III} [ \frac{1}{2} ( 1 - C ) ] & ( 55 ) \\ {d}_{4} = {d}_{IV} [ \frac{1}{2} ( 1 + C ) ] = {V}_{Max} & ( 56 ) \\ {d}_{5} = {d}_{V} [ \frac{1}{2} ( 1 + C ) + A ] & ( 57 ) \\ {d}_{6} = {d}_{VI} ( 1 - A ) & ( 58 )\end{matrix}$$

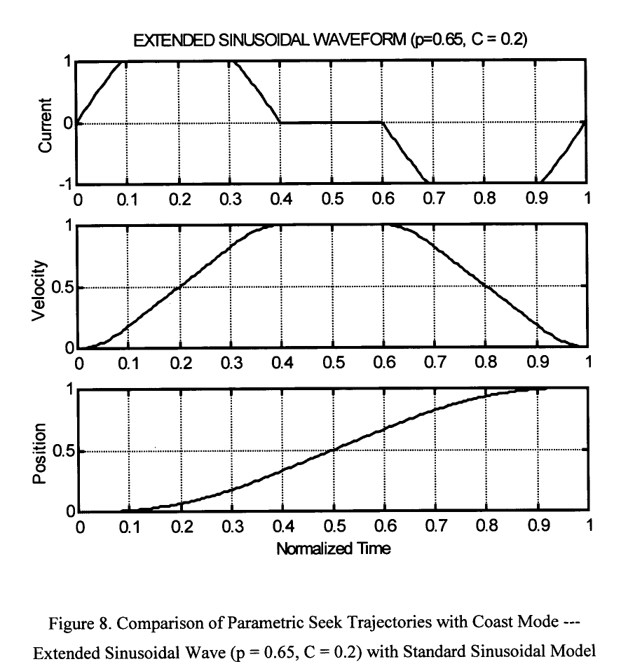

FIG. 8 shows the seek trajectories for the extended sinusoidal current waveform with p=0.65 and C=0.2. The top trace is the trajectory showing normalized current versus normalized time. Shown in the middle trace is the normalized velocity trajectory as a function of the normalized time. The bottom trace in FIG. 8 shows the normalized position trajectory versus the normalized time.

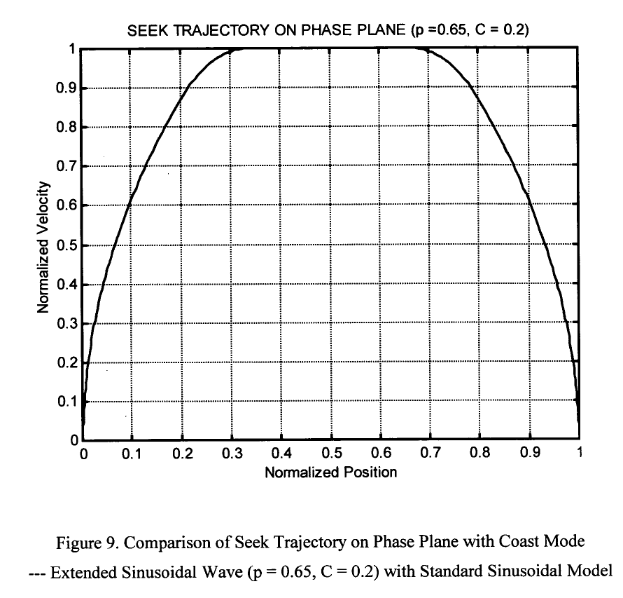

The velocity trajectory and the position trajectory in FIG. 8 are combined into a single seek trajectory on the phase plane by eliminated the variable of time from these two trajectories. The combined seek trajectory is shown on the phase plane in FIG. 9 with the coordinate as the velocity and the abscissa as the position.

5. Seek Time as a Function of Seek Length

Seek time in the following refers to the movement time of a transducer from one location to another without the inclusion of settling time for the transducer to be ready for read or write operation at the new location.

The comparison given below applies to seek without coast mode only.

For any general current profile, the relationship between seek length (X_{SK}) and seek time (T_{SK}) is given by the following equation.

$${T}_{SK} = ψ \sqrt{\frac{1}{{K}_{VCM} {I}_{MAX}} {X}_{SK}} = ψ \sqrt{\frac{J}{{K}_{T} {I}_{MAX}} {X}_{SK}} . \qquad ( 59 )$$

where
K_{VCM}=K_{T}/J=VCM constant,
K_{T}=VCM torque constant,
J=Mass moment of the inertia,
I_{MAX}=Maximum current

The constant Ψ in Eq. (59) is determined from the boundary condition, which leads to the following equation.

$$ψ = \sqrt{\frac{p}{{d}_{V} ( 1 )}} . \qquad ( 60 )$$

In Eq. (60) the parameter p is the limitation level of sine function as defined in Eq. (1), and dᵥ(1), computed using the phase V position trajectory given in Eq. (17), stands for the dimensionless seek length at the end of seek.

The parameter Ψ for sinusoidal seek profiles is
Ψ=\sqrt{2π}. (61)

For bang-bang current profile, the parameter v becomes
Ψ=2. (62)

For a rigid body motion subjected to a constant acceleration only (no deceleration), the parameter Ψ is given by
Ψ=\sqrt{2}. (63)

The parameter Ψ for the extended sinusoidal waveform is proportional to the square root of another waveform-dependent parameter p as shown in Eq. (60). This parameter Ψ falls in between the two limits.
2<Ψ<\sqrt{2π}. (64)

Since the waveform is so complicated, there is no closed form representation for this parameter. Numerical solutions, however, are available for the parameter Ψ, which are summarized in Table 1 below for various different p values.

TABLE 1
Relationship between A*, p and ψ, for the Extended Sine Wave

| p | A | B | ψ | Comment |
|---|---|---|---|---|
| 0.1 | 0.0159 | 0.4682 | 2.0329 | Getting closer to bang-bang trajectory |
| 0.2 | 0.0320 | 0.4360 | 2.0681 | |
| 0.3 | 0.0485 | 0.4030 | 2.1050 | |
| 0.4 | 0.0655 | 0.3690 | 2.1444 | |
| 0.5 | 0.0833 | 0.3334 | 2.1878 | |
| 0.6 | 0.1024 | 0.2952 | 2.2363 | |
| 0.7 | 0.1234 | 0.2532 | 2.2891 | |
| 0.8 | 0.1476 | 0.2048 | 2.3467 | |
| 0.9 | 0.1782 | 0.1436 | 2.4208 | |
| 1.0 | 0.2500 | 0.0000 | 2.5155 | Sinusoidal seek trajectory |

$* Note \text{:} B = \frac{1}{2} - 2 A$

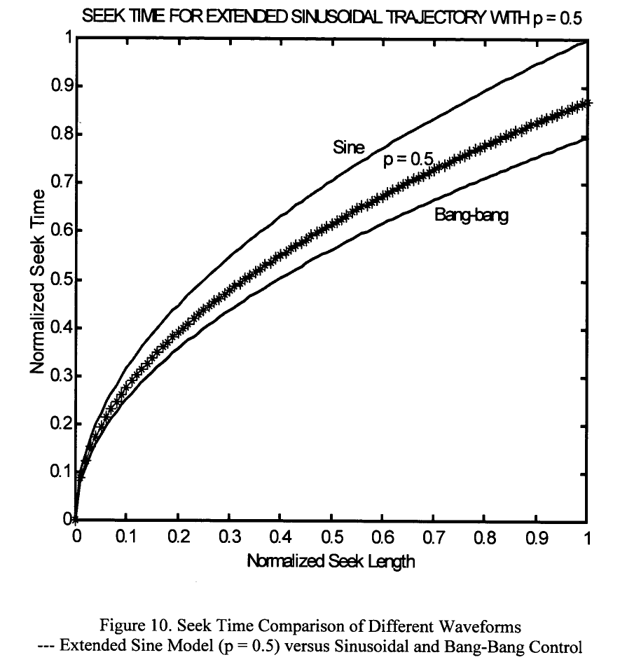

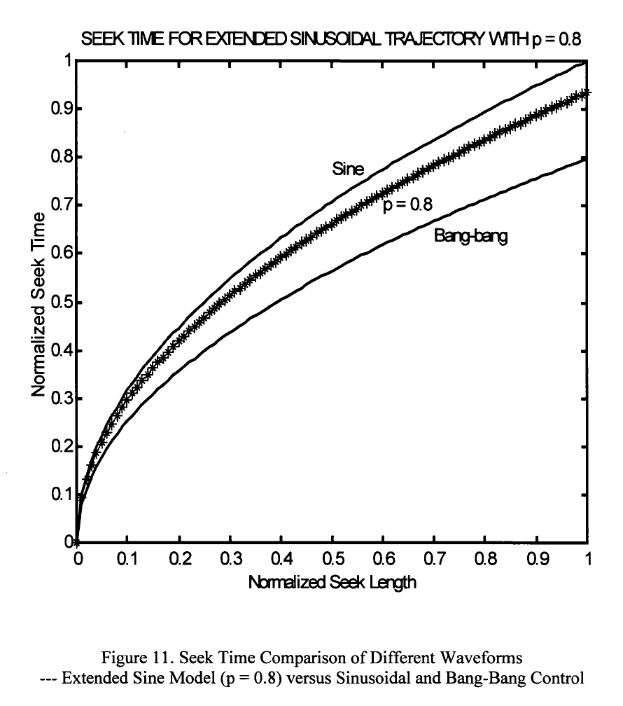

It is easy to make movement time comparison for relatively short seeks without coast mode. FIG. 10 shows the seek time comparison for servo seek mechanism with bang-bang control, sinusoidal seek method and extended sinusoidal seek waveform with p=0.5 as current profile, respectively. It is noted that the bang-bang control algorithm has the shortest seek time, and the sinusoidal seek has the slowest seek time. The seek time for the extended sinusoidal seek model falls in between these two extremes. However, the seek time for the extended sinusoidal seek model is adjustable. As the parameter p of the extended sinusoidal waveform gets smaller, the waveform gets closer to the bang-bang current trajectory, and its corresponding seek time also gets shorter. FIG. 11 is the seek time comparison for servo systems with these three different current profiles: bang-bang control, extended sinusoidal waveform with p=0.8 and the sinusoidal seek method.

6. Seek Controller Design

There are two different seek controllers available:
(1) Seek controller using seek trajectories of parametric form
(2) Seek controller on the phase plane

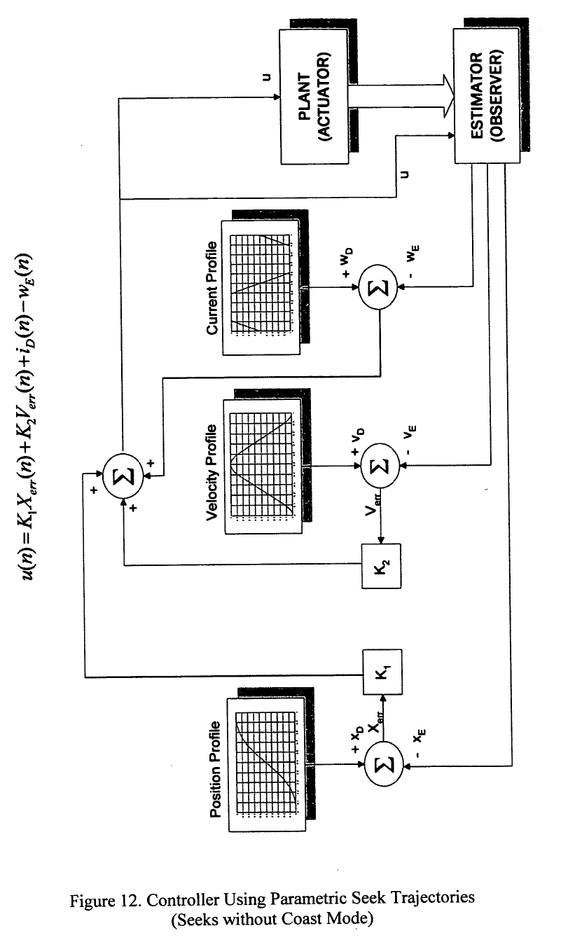

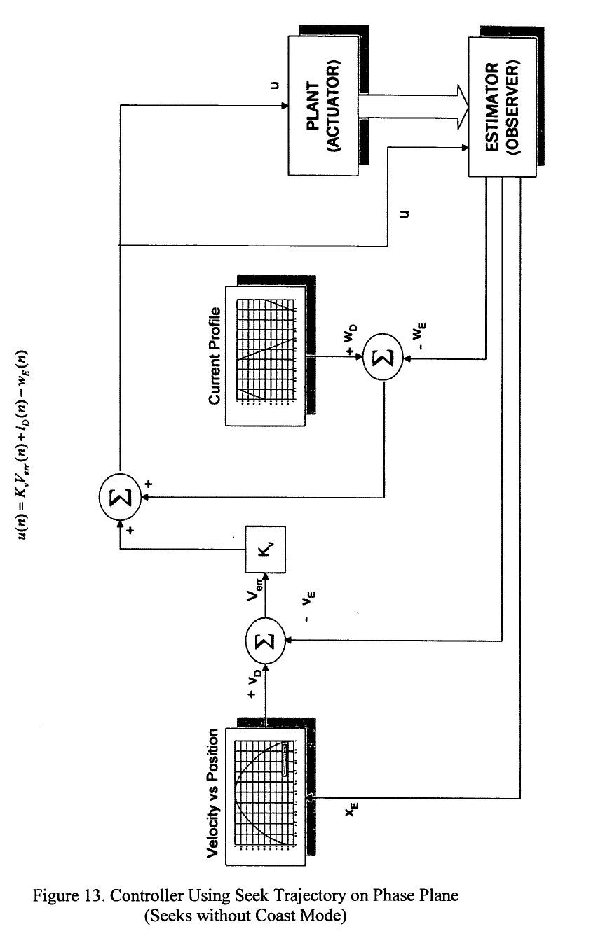

When there is no coast mode involve in the seek, the controller for seek can be either one of the designs shown in FIG. 12 and FIG. 13 for parametric form and phase-plane form, respectively.

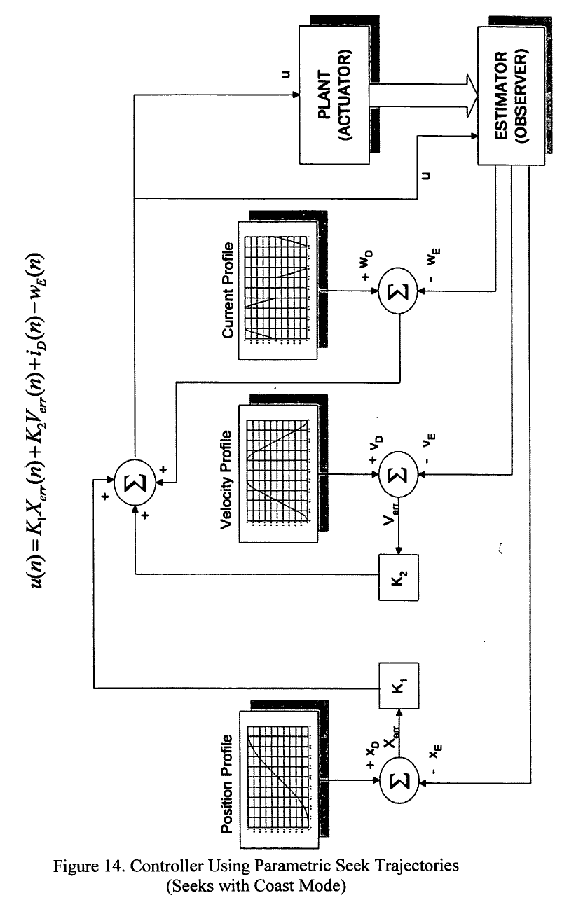

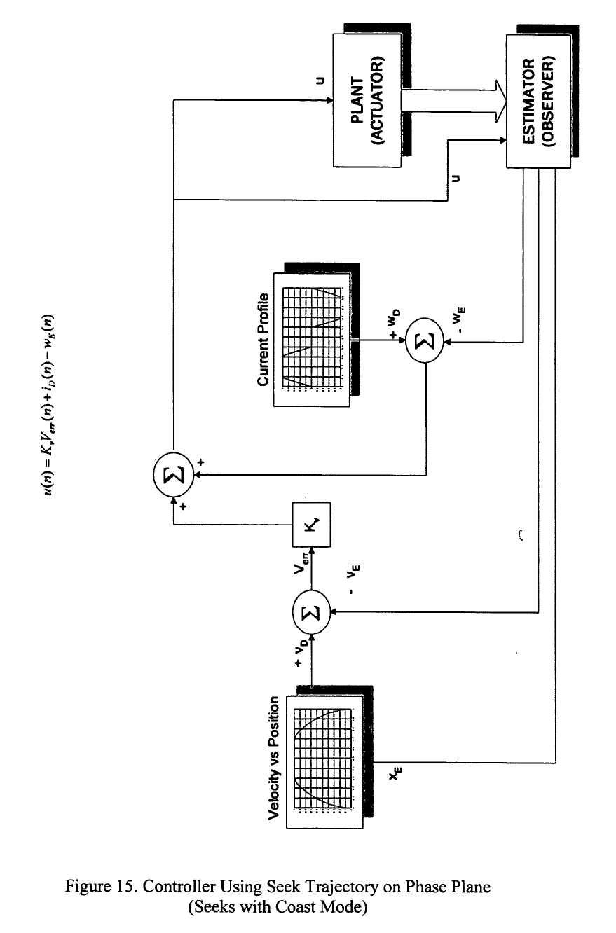

For longer seeks with coast mode, the controller for seek can be either one of the designs shown in FIG. 14 and FIG. 15 for parametric form and phase-plane form, respectively.

The control current for the parametric form seek controller (FIG. 12 or FIG. 14) is, given by
u(n)=K₁Xₑᵣᵣ(n)+K₂Vₑᵣᵣ(n)+i_{D}(n)−w_{E}(n) (65)

For seek controller on the phase plane, the controller current (FIG. 13 or FIG. 15) is computed as follows.
u(n)=K_{V}Vₑᵣᵣ(n)+i_{D}(n)−w_{E}(n) (66)

Note that the parametric trajectories are explicitly dependent on time. The seek trajectory is explicitly dependent on position; however, it is implicitly dependent on time.

7. Summary and Usage of Trajectory

The extended sinusoidal current profile is a new class of waveform devised to improve the robustness of the conventional bang-bang control algorithm of seeks for servomechanism in hard disk drive application, and, at the same time, retaining near time-optimal seek performance. Compared to the sinusoidal seek algorithm, the extended sinusoidal current profile can much improve the seek time while maintaining descent robustness in control.

The generation of the current profile for the extended sinusoidal seek is made by limiting the sine wave not to exceed a saturation level of p (0<p<1). When the sine wave is larger than p, the current saturates at the level of p; and, on the other hand, the current is set to −p when the current falls to be less than p. The current trajectory is then normalized so that the current falls within the range of ±1.

The extended sinusoidal waveform includes the conventional bang-bang control waveform and the sinusoidal waveform as its two opposite limiting cases when the duration of constant current profile is always at its peak and, for the other extreme, the constant duration does not exist, respectively.

The new current trajectory can be very valuable under certain circumstances. First, when the servo system design is pursuing a faster seek time, the new trajectory is used by extending the duration of current at peak instead of increasing the magnitude of the peak, which, usually, is not possible. Second, under the restriction of certain VCM driver, one may not have a choice to raise maximum current for VCM to meet the criterion of design seek time. Commonly, a hard drive is designed for extreme operating conditions such as 55° C. environment with 10% supply voltage reduction. The extended sine wave allows the design engineer to reduce the maximum current and, at the same time, to increase the duration of constant acceleration. Consequently, seek time for a recording head in a long seek can still be faster.

What is claimed is:

1. A hard disk drive, comprising:
(a) a disk which has a surface;
(b) a spindle motor that rotates said disk;
(c) a transducer which can write information onto said disk and read information from said disk;
(d) an actuator arm that can move said transducer across said surface of said disk; and,
(e) a controller that controls said actuator arm so that said transducer moves across said disk surface with an essentially extended sinusoidal acceleration trajectory.

2. The disk drive of claim 1, wherein said controller is a digital signal processor.

3. The hard disk drive of claim 2, wherein said digital signal processor controls said actuator arm in accordance with a seek controller algorithm.

4. The hard disk drive of claim 1, wherein said controller performs a servo routine that outputs current to vary the movement of said transducer.

5. The hard disk drive of claim 4, wherein said current is a function of design trajectories and actual position, velocity and bias of the transducer.

6. The hard drive of claim 5, wherein said design trajectories are acceleration, velocity and position trajectories derived from extended sinusoidal current profile.

7. A method for moving a transducer across a surface of a disk with a controller, comprising the steps of:
(a) exciting an actuator arm that is coupled to the transducer so that the transducer moves across the disk surface with an extended sinusoidal current trajectory.
(b) computing a design position for the transducer;
(c) determining an actual position of the transducer;
(d) generating a position correction current that is proportional to the difference of the design position and the actual position;
(e) computing a design velocity for the transducer;
(f) determining an actual velocity of the transducer;
(g) generating a velocity correction current that is proportional to the difference of the design velocity and the actual velocity;
(h) computing a design current for the transducer;
(i) determining bias current for the transducer;
(j) generating an exciting current to excite the actuator arm that is the sum of position correction current, velocity correction current and the design current subtracted by bias current;
(k) varying the movement of the transducer in response to said exciting current.

8. The method of claim 7, wherein said controller uses separate position and velocity trajectories derived from extended sinusoidal current profile.

9. The method of claim 7, wherein said design position is computed based on design acceleration trajectory with extended sinusoidal waveform.

10. The method of claim 7, wherein said design velocity is computed based on design acceleration trajectory with extended sinusoidal waveform.

11. The method of claim 7, wherein said design current is generated using the extended sinusoidal current trajectory.

12. A method for moving a transducer across a surface of a disk with a seek controller, comprising the steps of:
(a) exciting an actuator arm that is coupled to the transducer so that the transducer moves across the disk surface with an extended sinusoidal current trajectory.
(b) computing a design position for the transducer;
(c) determining an actual position of the transducer;
(d) computing a design velocity for the transducer;
(e) generating seek trajectory on the phase plane using the design position as abscissa and the design velocity as the coordinate;
(f) determining an actual velocity of the transducer;
(g) extracting a design velocity of the transducer for the actual position from the seek trajectory;
(h) generating a velocity correction current that is proportional to the difference of design velocity and the actual velocity;
(i) computing a design current for the transducer;
(j) determining bias current for the transducer;
(k) generating current to excite the actuator arm that is the sum of velocity correction current and the design current subtracted by bias current;
(l) varying the movement of the transducer in response to the generation of the current output.

13. The method of claim 12, wherein said controller uses a combined position and velocity seek trajectory on the phase plane.

14. The method of claim 12, wherein said design position is computed in accordance with design acceleration trajectory with extended sinusoidal waveform.

15. The method of claim 12, wherein said design velocity is computed in accordance with design acceleration trajectory with extended sinusoidal waveform.

16. The method of claim 12, wherein said design current is generated using the extended sinusoidal current trajectory.
